(19) United States
(12) Patent Application Publication
(10) Pub. No.: US 2021/0309533 A1
(43) Pub. Date: Oct. 7, 2021

(54) Method of purifying sodium bromide from waste circuit boards pyrolysis coke

(71) Applicant: BEIJING UNIVERSITY OF TECHNOLOGY, BEIJING (CN)

(72) Inventors: Yufeng WU, BEIJING (CN); Gongqi LIU, BEIJING (CN); De-an PAN, BEIJING (CN)

(21) Appl. No.: 17/351,083

(22) Filed: Jun. 17, 2021

Related U.S. Application Data
(63) Continuation of application No. PCT/CN2020/127972, filed on Nov. 11, 2020.

(30) Foreign Application Priority Data
Dec. 25, 2019 (CN) 201911359343.6

(51) Int. Cl. C01D 3/10; C22B 1/06; C01D 3/18; C22B 26/10

(52) U.S. Cl. CPC C01D 3/10; C22B 26/10; C01D 3/18; C22B 1/06

(57) ABSTRACT

A method for purifying sodium bromide by the waste circuit board pyrolysis coke, belonging to the field of purifying sodium bromide and high-value utilization, and more particularly, relating to a method for reducing and purifying crude bromine salt enriched from waste circuit board smelting ash by using waste circuit boards pyrolysis coke. The main steps are as follows: carbonization conversion, purification filtration and vacuum exsolution. The pure sodium bromide crystal was obtained by reducing crude bromine salt enriched from waste circuit board smelting ash by using coke in waste circuit board pyrolysis residues, realizing the resource coupling and high-value utilization of the two wastes, avoiding the secondary pollution in the process of recycling the waste circuit boards. It has the characteristics of simple operation, high resource utilization rate and no tail liquid discharge.

### CROSS-REFERENCE TO RELATED APPLICATIONS

This application is a continuation of International Application No. PCT/CN2020/127972, filed on Nov. 11, 2020, which claims priority to Chinese Patent Application No.

201911359343.6, filed on Dec. 25, 2019, both of which are hereby incorporated by reference in their entireties.

### FIELD IN THE INVENTION

The invention relates to a recovery technology for collaborative treatment and high value utilization of smelting and waste circuit board pyrolysis residues, especially relating to a new method for reducing crude bromine salt enriched from waste circuit board smelting ash using the coke in waste circuit board pyrolysis residues.

### BACKGROUND TECHNOLOGY

Waste circuit boards is the most valuable part in waste electronic appliances, but it is difficult to be treated, and its treatment is the core of high value utilization of electronic appliances. At present, the main treatment methods are physical separation, pyrometallurgy treatment and hydrometallugy treatment, as well as gradually developing biological treatment technologies. The treatment characteristics of these recovery technologies are shown in table 1. Among them, metal and nonmetal enrichment can be obtained by physical separation, hydrometallurgy and biometallurgy are mostly focused on the recovery of metals in circuit boards, while metal alloy can be quickly obtained and nonmetal resources can be used by smelting and pyrolysis in pyrometallurgy technology, which has a good volume reduction effect. Pyrometallurgy and pyrolysis technology are considered to be the most effective technology for high value utilization of waste circuit boards, which can effectively recover metal, resin and fiberglass.

TABLE 1
Comparison of main treatment technologies for waste circuit boards

| | | | | | Effect of | Separation |
|---|---|---|---|---|---|---|
| | | | | | Volume | Effect of |
| Treatment | Treatment | Recovery | Secondary | Operation | and Mass | Nonmetal |
| Technology | Speed | Product | Pollution | Cost | Reduction | Material |
| Smelting | Fast | Thermal | High | High | Best | Good |
| treatment | | energy | | | | |
| Pyrolysis | Fast | Metal, oil, | Very low | Lower | Good | Best |
| treatment | | gas | | than | | |
| | | | | calcination | | |
| Physical | Faster | Metal, | Lower | Low | Medium | Bad |
| selection | | nonmetal | | | | |
| Hydrometallurgy | Faster | Metal | High | General | Medium | Bad |
| Biometallurgy | Slow | Metal | Low | Low | Bad | Bad |

With the progress of technologies, advanced and dissolvable smelting technology has been applied to the treatment of waste circuit boards and has been regarded as the mainstream technology for the treatment of waste circuit boards in Europe, America, Japan and other developed countries. Typically, Umicore uses ISA top blowing smelting technology to treat waste circuit boards and copper concentrates, and Boliden uses Kaldor furnace and Ausmelt top blowing smelting technology to treat mobile phone and computer circuit boards et al are successful cases of whole-body utilization. The successful implementation of this technology is conducive to fundamentally changing the traditional incineration mode and reducing the environmental problems caused by incineration. Due to the large amount of brominated flame retardant contained in circuit boards, there are a lot of bromides in the waste circuit board smelting ash. Application No. 201711490199.0 proposed a method of enriching the bromides in the smelting ash by sulphating roasting-alkali washing spray method to obtain crude bromine salt. This method has good effect on removing and enriching bromides in the circuit board smelting ash, but the obtained crude bromine salt has not been further purified and its high value utilization needs to be further studied.

The waste circuit boards are heated to a certain temperature in the presence or absence of oxygen by pyrolysis technology of waste circuit boards to decompose the organic matters, such as epoxy resin, into gas and liquid pyrolysis oil, while the metal and fiberglass remaining unchanged produce solid residues to be recovered. For the residues produced from pyrolysis, the current research mainly focuses on the comprehensive recovery of gas and oil and the recycling of metal in the pyrolysis residues, while the research on the recovery of nonmetal in the pyrolysis residues is less. The method of preparing polypropylene composites using fiberglass in circuit board pyrolysis residues application proposed in No. CN201010529818.4 realizes the high value utilization of fiberglass in pyrolysis residues, but the coke was directly calcined in the recovering process, instead of being recycled.

The by-product bromine salt obtained from the smelting and recovering process of waste circuit boards has high impurity content and different valence state of bromine salt. The traditional treatment method is to add pure reducing agent to get sodium bromide solution by heating reduction, and then bromine is obtained by electrodialysis membrane process or chlorination process, which has the disadvantages of high cost and complex operating environment. The recovery of waste circuit board pyrolysis residues often focuses on the recovery of metal and fiberglass, while the coke in which is often directly calcined, which wastes its resource value. In conclusion, in view of the characteristics of smelting and pyrolysis technology of waste circuit boards in China, as well as the treatment situation of secondary waste produced in the recovery process, it is urgent to develop full component recovery technology of waste circuit boards smelting and pyrolysis residues. The invention proposes a new method for reducing crude bromine salt enriched from waste circuit board smelting ash using the coke in waste circuit board pyrolysis residues, pure sodium bromide crystal is obtained through carbonization reduction, purification filtration and vacuum exsolution, realizing the resource coupling and integrated utilization of the two wastes, having the characteristics of simple operation, high resource utilization rate, environment-friendly, etc.

### SUMMARY OF THE INVENTION

The purpose of the invention is mainly to solve the problem of smelting of waste circuit boards and high value utilization of pyrolysis residues, and it proposes a new method for reducing crude bromine salt enriched from the waste circuit board smelting ash by using coke in waste circuit board pyrolysis residues, realizing the resource coupling and integrated utilization of the two wastes, and having the characteristics of simple operation, high resource utilization rate, environment-friendly, etc.

The method for purifying sodium bromide by the waste circuit board pyrolysis coke is as follows:

(1) Carbonization conversion: the crude bromine salt enriched from the waste circuit board smelting ash is mixed with the coke separated from the waste circuit board pyrolysis residues, then the uniform mixture is heated to obtain carbon monoxide and crude sodium bromide. Carbon monoxide is collected and used as raw material of water gas, in which the mass of coke is 0.1˜1.0 kg per kilogram of crude bromine salt, the reaction temperature is 250˜450 ° C., and the reaction time is 1.0˜2.0 h;

(2) Purification filtration: the crude sodium bromide obtained in step (1) is added to distilled water for purification filtration to obtain impurity residues and sodium bromide solution. The impurity residues are centralizedly treated, in which the liquid-solid volume mass ratio is 8:1˜3:1 (L/kg), the reaction temperature is 50˜80° C., and the reaction time is 20˜60 min;

(3) Vacuum exsolution: the sodium bromide solution obtained in step (2) is treated by vacuum exsolution to obtain sodium bromide crystal and exsolution mother liquor, then the exsolution mother liquor is returned to the purification filtration process, in which the reaction time is 30˜60 min and the reaction temperature is 60˜150° C.

Compared with the prior art, the present invention uses one kind of waste generated in the recycling process of waste circuit boards to treat another kind of waste, using coke in the waste circuit board pyrolysis residues as reducing agent to reduce the crude bromine salt enriched in the waste circuit board smelting ash, so as to reduce the high valence bromate in the crude bromine salt to produce pure sodium bromide crystal without additional reducing agent in the implementation process and no other impurities is introduced, realizing the resource coupling and integrated utilization of the two wastes, and having the characteristics of simple operation, high resource utilization rate, environment-friendly, etc.

### DESCRIPTION OF DRAWINGS

FIG. 1 shows the process flow diagram of enriching crude bromine salt from waste circuit board smelting ash.

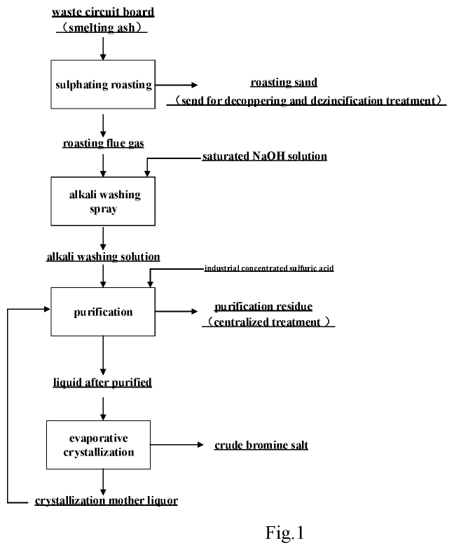

FIG. 2 shows the process flow diagram of separating waste circuit board pyrolysis coke.

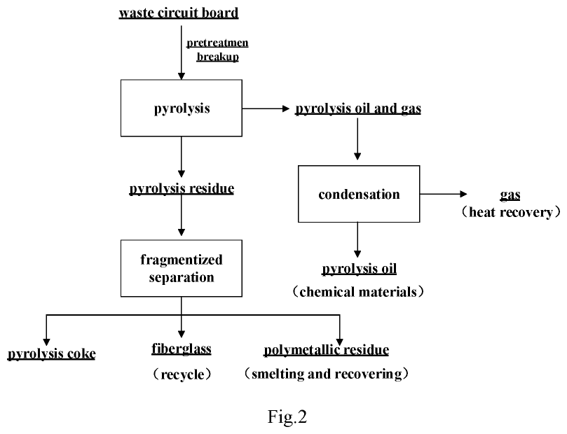

FIG. 3 shows the process flow diagram of purifying sodium bromide from waste circuit board pyrolysis coke.

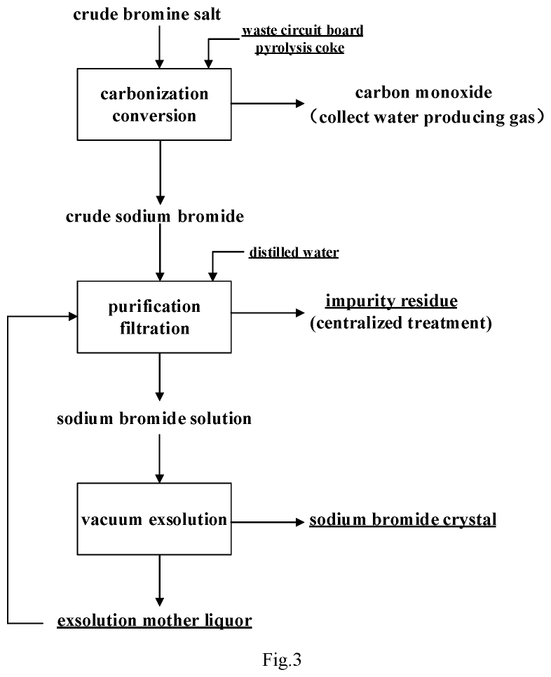

### EXEMPLARY EMBODIMENTS

The following exemplary embodiments are intended to further illustrate the invention rather than limit it.

Exemplary Embodiment 1

The recovery steps are as follows:

(1) Carbonization conversion: the crude bromine salt enriched from the waste circuit board smelting ash is mixed with the coke separated from the waste circuit board pyrolysis residues. The uniform mixture is heated to obtain carbon monoxide and crude sodium bromide. Carbon monoxide is collected and used as raw material of water gas, in which the mass of coke is 0.1 kg per kilogram of crude bromine salt, the reaction temperature is 250° C., and the reaction time is 1.0 h;

(2) Purification filtration: the crude sodium bromide obtained in step (1) is added to distilled water for purification filtration to obtain impurity residues and sodium bromide solution. The impurity residues are centralizedly treated, in which the liquid-solid volume mass ratio is 8:1 (L/kg), the reaction temperature is 50° C., and the reaction time is 20 min;

(3) Vacuum exsolution: the sodium bromide solution obtained in step (2) is treated by vacuum exsolution to obtain sodium bromide crystal and exsolution mother liquor, and the exsolution mother liquor is returned to the purification filtration process, in which the reaction time is 60min and the reaction temperature is 60° C.

The purity of the obtained sodium bromide crystal is 98.6%, which meets the standard of the first grade sodium bromide (NaBr≥98.5%) in the standard HG/T 3809-2006 of State Ministry of Chemical Industry.

Exemplary Embodiment 2

The recovery steps are as follows:

(1) Carbonization conversion: the crude bromine salt enriched from the waste circuit board smelting ash is mixed with the coke separated from the waste circuit board pyrolysis residues. The uniform mixture is heated to obtain carbon monoxide and crude sodium bromide. Carbon monoxide is collected and used as raw material of water gas, in which the mass of coke is 1.0 kg per kilogram of crude bromine salt, the reaction temperature is 450° C., and the reaction time is 2.0 h;

(2) Purification filtration: the crude sodium bromide obtained in step (1) is added to distilled water for purification filtration to obtain impurity residues and sodium bromide solution. The impurity residue are centralizedly treated, in which the liquid-solid volume mass ratio is 3:1 (L/kg), the reaction temperature is 80° C., and the reaction time is 60 min;

(3) Vacuum exsolution: the sodium bromide solution obtained in step (2) is treated by vacuum exsolution to obtain sodium bromide crystal and exsolution mother liquor, and the exsolution mother liquor is returned to the purification filtration process, in which the reaction time is 30 min and the reaction temperature is 150° C.

The purity of the obtained sodium bromide crystal is 99.4%, which meets the standard of the superior product sodium bromide (NaBr≥99%) in the standard HG/T 3809-2006 of State Ministry of Chemical Industry.

Exemplary Embodiment 3

The recovery steps are as follows:

(1) Carbonization conversion: the crude bromine salt enriched from the waste circuit board smelting ash is mixed with the coke separated from the waste circuit board pyrolysis residues. The uniform mixture is heated to obtain carbon monoxide and crude sodium bromide. Carbon monoxide is collected and used as raw material of water gas, in which the mass of coke is 0.4 kg per kilogram of crude bromine salt, the reaction temperature is 300° C., and the reaction time is 1.2 h;

(2) Purification filtration: the crude sodium bromide obtained in step (1) is added to distilled water for purification filtration to obtain impurity residues and sodium bromide solution. The impurity residues are centralizedly treated, in which the liquid-solid volume mass ratio is 7:1 (L/kg), the reaction temperature is 60° C., and the reaction time is 25 min;

(3) Vacuum exsolution: the sodium bromide solution obtained in step (2) is treated by vacuum exsolution to obtain sodium bromide crystal and exsolution mother liquor, and the exsolution mother liquor is returned to the purification filtration process, in which the reaction time is 50 min and the reaction temperature is 100° C.

The purity of the obtained sodium bromide crystal is 98.8%, which meets the standard of the first grade sodium bromide (NaBr≥98.5%) in the standard HG/T 3809-2006 of State Ministry of Chemical Industry.

Exemplary Embodiment 4

The recovery steps are as follows:

(1) Carbonization conversion: the crude bromine salt enriched from the waste circuit board smelting ash is mixed with the coke separated from the waste circuit board pyrolysis residues. The uniform mixture is heated to obtain carbon monoxide and crude sodium bromide. Carbon monoxide is collected and used as raw material of water gas, in which the mass of coke is 0.8 kg per kilogram of crude bromine salt, the reaction temperature is 400° C., and the reaction time is 1.8 h;

(2) Purification filtration: the crude sodium bromide obtained in step (1) is added to distilled water for purification filtration to obtain impurity residues and sodium bromide solution. The impurity residues are centralizedly treated, in which the liquid-solid volume mass ratio is 6:1 (L/kg), the reaction temperature is 75° C., and the reaction time is 50 min;

(3) Vacuum exsolution: the sodium bromide solution obtained in step (2) is treated by vacuum exsolution to obtain sodium bromide crystal and exsolution mother liquor, and the exsolution mother liquor is returned to the purification filtration process, in which the reaction time is 40 min and the reaction temperature is 130° C. The purity of the obtained sodium bromide crystal is 99.2%, which meets the standard of the superior product sodium bromide (NaBr≥99%) in the standard HG/T 3809-2006 of State Ministry of Chemical Industry.

Exemplary Embodiment 5

The recovery steps are as follows:

(1) Carbonization conversion: the crude bromine salt enriched from the waste circuit board smelting ash is mixed with the coke separated from the waste circuit board pyrolysis residues. The uniform mixture is heated to obtain carbon monoxide and crude sodium bromide. Carbon monoxide is collected and used as raw material of water gas, in which the mass of coke is 0.5 kg per kilogram of crude bromine salt, the reaction temperature is 350° C., and the reaction time is 1.5 h;

(2) Purification filtration: the crude sodium bromide obtained in step (1) is added to distilled water for purification filtration to obtain impurity residues and sodium bromide solution. The impurity residues are centralizedly treated, in which the liquid-solid volume mass ratio is 4:1 (L/kg), the reaction temperature is 70° C., and the reaction time is 40 min;

(3) Vacuum exsolution: the sodium bromide solution obtained in step (2) is treated by vacuum exsolution to obtain sodium bromide crystal and exsolution mother liquor, and the exsolution mother liquor is returned to the purification filtration process, in which the reaction time is 45 min and the reaction temperature is 120° C.

The purity of the obtained sodium bromide crystal is 98.9%, which meets the standard of the first grade sodium bromide (NaBr≥98.5%) in the standard HG/T 3809-2006 of State Ministry of Chemical Industry.

Exemplary Embodiment 6

The recovery steps are as follows:

(1) Carbonization conversion: the crude bromine salt enriched from the waste circuit board smelting ash is mixed with the coke separated from the waste circuit board pyrolysis residues. The uniform mixture is heated to obtain carbon monoxide and crude sodium bromide. Carbon monoxide is collected and used as raw material of water gas, in which the mass of coke is 0.6 kg per kilogram of crude bromine salt, the reaction temperature is 350° C., and the reaction time is 1.6 h;

(2) Purification filtration: the crude sodium bromide obtained in step (1) is added to distilled water for purification filtration to obtain impurity residues and sodium bromide solution. The impurity residues are centralizedly treated, in which the liquid-solid volume mass ratio is 5:1 (L/kg), the reaction temperature is 70° C., and the reaction time is 45 min;

(3) Vacuum exsolution: the sodium bromide solution obtained in step (2) is treated by vacuum exsolution to obtain sodium bromide crystal and exsolution mother liquor, and the exsolution mother liquor is returned to the purification filtration process, in which the reaction time is 30min and the reaction temperature is 80° C.

The purity of the obtained sodium bromide crystal is 99.1%, which meets the standard of the superior product sodium bromide (NaBr≥99.0%) in the standard HG/T 3809-2006 of State Ministry of Chemical Industry. The above embodiments are only used to illustrate the preferred embodiments of the invention, but the invention is not limited to the above embodiments. Within the scope of knowledge possessed by those skilled in the art and on the premise of not departing from the science and design spirit in the invention, the modifications, equivalent substitutions and improvements et al. made on the spirit and principles of the invention shall be regarded as in the scope of protection of the application.

1. A method for purifying sodium bromide from waste circuit board pyrolysis coke, characterized by the following specific steps:
(1) carbonization conversion: crude bromine salt enriched from waste circuit board smelting ash is mixed with coke separated from waste circuit board pyrolysis residues to form a uniform mixture, the uniform mixture is heated to obtain carbon monoxide and crude sodium bromide, the carbon monoxide is collected and used as raw material of water gas, in which a mass of the coke is 0.1-1.0 kg per kilogram of the crude bromine salt, reaction temperature is 250-450° C., and reaction time is 1.0-2.0 h;
(2) purification filtration: the crude sodium bromide obtained in step (1) is added to distilled water for purification filtration to obtain impurity residues and sodium bromide solution, the impurity residues are centralizedly treated;
(3) vacuum exsolution: the sodium bromide solution obtained in step (2) is treated by vacuum exsolution to obtain sodium bromide crystal and exsolution mother liquor, and the exsolution mother liquor is returned to purification filtration process.

2. A method for purifying sodium bromide from waste circuit board pyrolysis coke according to claim 1, characterized in that, in the process of purification filtration, a liquid-solid volume mass ratio is 8:1-3:1 (L/kg), reaction temperature is 50-80° C., and reaction time is 20 -60 min.

3. A method for purifying sodium bromide from waste circuit board pyrolysis coke according to claim 1, characterized in that, in the process of vacuum exsolution, reaction time is 30-60 min and reaction temperature is 60-150° C.
